(19) United States
(12) Patent Application Publication
(10) Pub. No.: US 2018/0210883 A1
(43) Pub. Date: Jul. 26, 2018

(54) SYSTEM FOR CONVERTING NATURAL LANGUAGE QUESTIONS INTO SQL-SEMANTIC QUERIES BASED ON A DIMENSIONAL MODEL

(71) Applicant: Dony Ang, La Habra, CA (US)

(72) Inventor: Dony Ang, La Habra, CA (US)

(21) Appl. No.: 15/414,626

(22) Filed: Jan. 25, 2017

(51) Int. Cl. G06F 17/30; G06N 99/00

(52) U.S. Cl. CPC G06F 17/3043; G06N 99/005; G06F 17/30554; G06F 17/30592

(57) ABSTRACT

A program is provided for organizing and converting a natural language, such as but not limited to English, into a SQL-based query by using natural language processing technique called named entity recognition for recognizing different types of entities such as dimension, metric and date/time entities. Once these entities are identified, the SQL query can be constructed by joining all the identified entities above and run this newly created SQL against dimensional model schema of data warehouse.

This specification benefits claims in provisional application No. 62/286,645

### BACKGROUND OF THE INVENTION

In recent times, business intelligence has become a staple in many organizations worldwide. The term “data-driven company” is ubiquitous across all types of businesses, from startups to Fortune 500 companies. With the introduction of cloud-based data warehouse services (e.g., Redshift, Google Big Query, EMR, Hadoop on Cloud, etc.) in recent years, the efficiency and speed at which scalable analytic solutions may be designed from the ground up has increased. However, there still exists a need for an accessible and easy-to-use business intelligence tool that facilitates the manner in which business users can derive analytical insights from data. Traditionally, organizations employ a group of data analysts and business intelligence developers to create/build dashboards/analytical reports based on data for presentation to business users; these specialized skilled professionals may become encumbered/burdened by administrative work while creating/building dashboards/analytical reports, resulting in potential time loss for business users to gain analytical insights as they wait for the dashboards/analytical reports.

As mentioned above, data management platforms have become a must-have commodity for different types of organizations. A data management platform without an accessible easy-to-use business intelligence tool that is accessible and easy-to-use, however, may not help organizations leverage their investments in setting up big data infrastructures.

This invention minimize the gap between investments made in setting up big data infrastructures and business intelligence consumptions by leveraging natural language processing technology. Embodiments of the invention provide a technology that can be used to provide business answers for business questions in the natural language (i.e., human language) by converting the questions into SQL dialects, and presenting answers to the questions as insightful visualizations for immediate consumption of analytics by business users.

### SUMMARY OF THE INVENTION

The invention described in the detailed description section below shows the step by step processes and methodologies in converting natural languages for asking business questions and break them down into phrases of action, metric & dimension names, dimensional values, timeframe and conditions. Once all these phrases have been identified then the system will convert and compile them into compatible SQL-syntax based on set of rules or known as heuristic rules and run this newly generated SQL against user data warehouse/big-data platform.

The identification process of metrics, dimensions and dimensional value(s) is done by comparing metrics and dimensions available within user's own Data Warehouse. Prior to answering user business question(s), the system would require user to do manually mapping of their own data warehouse schema which normally done in the Dimensional Model Structure by identifying sets of dimensions and facts/metrics and store these metadata information into RDBMS. When user asks business questions, the metrics, dimensions and dimensional values are validated against this metadata information.

However, the same process for identifying timeframe requires to use natural language processing such as POS tagger and Named Entity Recognition to identify the date and time component within user request(s). Conditions can also leverage natural language processing if there is a numerical component within the conditional phrases involved.

Once all these phrases are identified and mapped against metadata and the system knows the metric and dimensions involved then system would start constructing the generic Data Warehouse SQL syntax heuristically as follow:

| | |
|---|---|
| SELECT | <identified dimension(s)>, |
| | < aggregation operation( < identified metric name > ) |
| FROM | <fact table > |
| WHERE | < condition(s) stated in the user question > |
| GROUP BY | < identified dimension> |

A good example of user business question would be “Tell me how much sales do we have for year of 2015 broken up by department” then the expected generated SQL syntax would be:

| | |
|---|---|
| SELECT | department, |
| | sum( sales ) |
| FROM | fact_sales |
| WHERE | year= ‘2015’ |
| GROUP BY | department |

### BRIEF DESCRIPTION OF DRAWINGS

For a fuller understanding of the nature of the present invention, reference should be had to the following detailed description taken in connection with the accompanying drawing in which:

FIG. 1 is a schematic representation of one of the embodiment of conversion from natural language spoken by user into SQL and Data Warehouse (or shown as storage) of the present invention

FIG. 2 is detailed schematic representation of the embodiment of the invention from the schema mapping all the way into the visualization as a result of translated/converted SQL.

FIG. 3 is the illustration of the schema mapping tool used to map out user dimensional model into metadata for training purposes.

FIG. 4 is the schematic representation of the data flow of metric extractor from the ingestion of metric phrases from metadata until the classifier Named-Entity for identifying metric is trained and used for detecting metric phrases in the user tokens

FIG. 5 is almost identical schematic representation as FIG. 4 with the exception that Named-Entity (or abbreviated as NER) is used to identify dimension instead of metric.

FIG. 6 is the schematic representation of identifying and extracting dimensional value(s) from user inquiry.

FIG. 7 is the schematic representation of identifying and extracting date or time from the user inquiry

FIG. 8 is another schematic representation of funneling the output of each of extractor into a SQL-generation engine.

FIG. 9 represents the heuristic table that has a list of SQL-generation rules for generating corresponding SQL based on the supplied dimensions, metrics, dimensional values and time/date.

FIG. 10 represents the heuristic table that has a list of recommended visualization based on the output from the execution of the generated SQL

### DETAILED DESCRIPTION

Embodiments of the invention provide a system for converting natural language questions into queries compatible with a data management platform (e.g., queries in SQL syntax) based on a dimensional model. In one embodiment, the system is configured to receive, as input, one or more spoken natural language questions captured via a microphone of an electronic device (e.g., a smartphone), and provide, as output, responses to the questions, wherein the responses may be rendered on a display of the electronic device in the form of text and/or graphics (e.g., graphs), and/or outputted as a synthesized voice response (e.g., narration using spoken word) via a speaker or headphone connected to the electronic device.

One embodiment addresses the needs of business users desiring more analytical insights from a data management platform without the need to employ a group of data analysts and business intelligence developers to create/build a complex business intelligence system.

One embodiment provides a system that allows users to ask questions related to their area/domain of interest and based on the availability of data in the data warehouse in the natural language form. The system converts the user questions in the natural language form to queries in a programming language compatible with the data management platform (e.g., ANSI SQL), runs the queries against a corresponding user data warehouse or a big data platform (e.g., a. JDBC/ODBC compatible data warehouse/big data platform), and presents results in the form of text, graphics (e.g., graphs) and/or a synthesized voice response (e.g., narration using spoken word). The system removes the need of employing a group of data analysts and business intelligence developers to manually create/build dashboards/analytical reports. The system allows a user to immediately gain analytical insights by posing questions directly to the system in natural language, and receiving answers from the system (e.g., akin to a Q&A session).

This specification describes step-by-step processes and methodologies utilized by the system to break down user questions asked in natural languages into different phrases, such as phrases of action, metrics, dimensions, dimensional values, timeframe and conditions. The system converts and compiles phrases into queries in a programming language compatible with a data management platform (e.g., ANSI SQL), and runs the queries against a user data warehouse or a big data platform.

In one embodiment, the system identifies phrases such as metrics, dimensions and dimensional values by comparing against metadata information including metric names, dimension names and dimensional values for a user data warehouse. At initialization, the system requires the user to provide a manual mapping of a schema of the user data warehouse. The mapping may be accomplished in the Dimensional Model Structure with the user identifying sets of dimensions and metrics, and storing metadata information including the identified sets in a relational database management system (RDBMS). Thereafter, when the user asks questions, any metrics, dimensions and dimensional values in the user questions are validated against the metadata information stored.

In one embodiment, the system identifies timeframes utilizing natural language processing techniques such as Part-Of-Speech Tagger (POS Tagger) and Named-Entity Recognition to identify one or more time components within user questions. The system may also identify conditions utilizing natural language processing techniques if there is a numerical component within the conditional phrases involved.

Once all phrases are identified and mapped against the metadata information stored, and the system has determined all metrics and dimensions the user questions pertain to, the system constructs queries in a programming language compatible with the data management platform.

Table 1 below provides an example query constructed by the system in generic data warehouse SQL syntax.

TABLE 1

SELECT <identified dimension(s)>,

<identified aggregation operation( < identified

metric name > )

FROM <fact table >

WHERE < condition(s) stated in the user question >

GROUP BY < identified dimension>

Table 2 below provides an example query constructed by the system in SQL syntax in response to a user question “Tell me how much sales do we have for year of 2015 broken up by department”.

TABLE 2
SELECT department,
sum ( sales )
FROM fact_sales
WHERE year =‘2015’
GROUP BY department

Before responding to questions from a user with relevant data obtained from a corresponding user data warehouse, the system performs the following steps: First, the system maps out one or more sets of dimensions and metrics from the user data warehouse for storage as metadata information in a RDBMS.

Second, the system parses the user questions into one or more phrases, and applies Named-Entity Recognition to each of the phrases to identify at least one of the following phrases: an action, a dimension, a metric, a dimensional value, a timeframe, and optionally a preferred visualization. The user has the option to not specify any of these phrases. For example, the user need not specify a preferred visualization; the default visualization may be employed if there is no preferred visualization specified.

Third, once all phrases have been identified, one or more queries in a compatible programming language (e.g., SQL syntax) are constructed and run against the user data warehouse. Results may be presented in the form of graphics (e.g., graphs) rendered using appropriate Visualization Engine (e.g., D3, Graph Engine, etc.), in the form of simple text and/or grids, and/or synthesized voice responses (e.g., narration using spoken word).

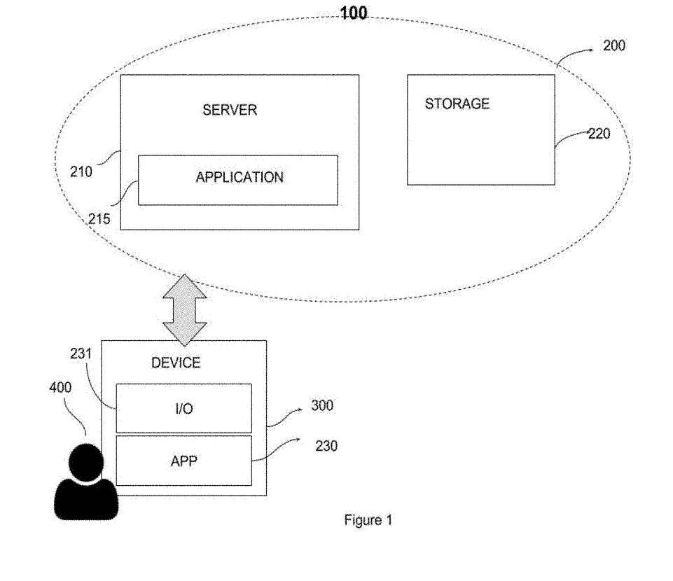

With reference to FIGS. 1-11C and Appendix A, embodiments of a system for converting natural language questions into queries compatible with a data management platform (e.g., queries in SQL syntax) based on a dimensional model are described herein below.

FIG. 1 illustrates an example system 100 for converting natural language questions into queries in SQL syntax based on a dimensional model, in accordance with one embodiment of the invention. The system 100 comprises a centralized computing environment 200 including one or more server devices 210, and one or more storage devices 220. As described in detail later herein, one or more applications 215 may execute/operate on the server devices 210 to provide a business intelligence tool configured to convert natural language questions into queries in SQL syntax based on a dimensional model.

A user 400 may access the business intelligence tool via an electronic device 300, such as a personal computer (e.g., a desktop computer) or a mobile device (e.g., a laptop computer, a tablet, a mobile phone, etc). In one embodiment, an electronic device 300 exchanges data with the business intelligence tool over a connection (e.g., a wireless connection, a wired connection, or a combination of the two). In one embodiment, a user 400 of an electronic device 300 may access the business intelligence tool via a mobile application 230 downloaded to the electronic device 300 or a web interface accessible via the electronic device 300.

The communication device 400 further comprises one or more input/output (I/O) devices 231, such as a touch screen, a keyboard, a telephone keypad, a microphone, a speaker, a display screen, etc. Results to user questions may be presented/provided to the user 400 utilizing at least one of the I/O devices 231.

As described in detail later herein, the business intelligence tool may interface with different data warehouses and/or big data platforms to query and retrieve information of interest to the user 400.

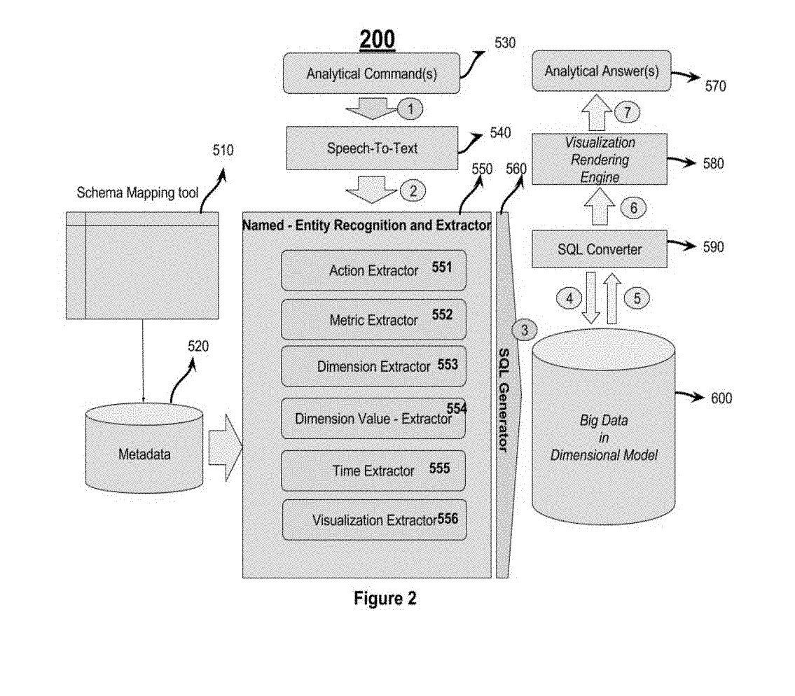

FIG. 2 illustrates the centralized computing environment 200 in detail, in accordance with an embodiment of the invention. As stated above, one or more applications 215 may execute/operate on the server devices 210 to provide a business intelligence tool configured to convert natural language questions into queries in SQL syntax based on a dimensional model. The applications 215 comprise a schema mapping tool 510 configured to connect a schema for a user data warehouse schema with sets of metrics and dimensions that will be made available for the user 400 to inquire about.

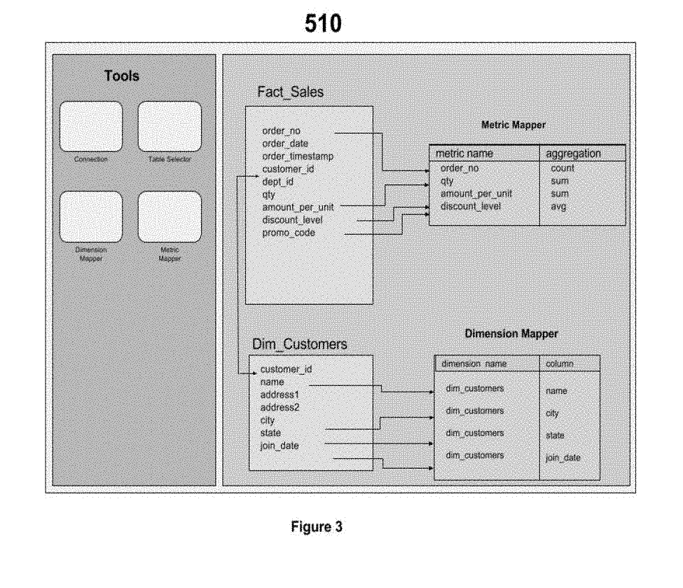

FIG. 3 illustrates an example schema mapping tool 510, in accordance with one embodiment. In one embodiment, the schema mapping tool 510 maps two different types of groups of schema. Specifically, the schema mapping tool 510 comprises a metric mapper and a dimension mapper.

The metric mapper is configured to map out all facts that will be exposed to users so that users can include them in their inquiries/questions. Aside from selecting one or more fact/metric names, the metric mapper is also configured to prompt a user 400 to choose an aggregation strategy for a selected metric name.

The dimension mapper allows a user 400 to select one or more types of dimension available to the user 400. Dimensional values may also be derived from this mapping.

Returning to FIG. 2, the applications 215 further comprise a speech recognition application programming interface (API) (“speech-to-text”) 540 and a named-entity recognition and extractor 550. The speech recognition API is configured to transcode/convert one or more user questions (“analytical command(s)”) 530 from speech to text, and forward the text to the named-entity recognition and extractor 550.

The named-entity recognition and extractor 550 is configured to extract one or more phrases/Named-Entities from the text. Examples of phrases/Named-Entities to extract include Named-Entities Action, Dimension, Dimension Value, Metric, Time, and Visualization. As stated above, a user 400 need not specify a preferred visualization (i.e., no Visualization is extracted from the text if a preferred visualization is not specified).

In one embodiment, before phrases/Named-Entities are extracted from the text, the system 200 applies a POS tagging process. The system 200 may use a standard corpus for tagging each token/phrase, such as the Brown corpus, Treebank, the conll200 corpus, etc.

Table 3 below illustrates example tokens obtained by applying POS tagger using Python NLTK to a user question “Show me the sales for the last 2 months”.

TABLE 3
[(‘show’, ‘VHP’), (‘me’, ‘PRP’), (‘the’, ‘DT’), (‘sales’,
‘NNS’), (‘for’, ‘IN’), (‘the’, ‘DT’), (‘last’,
‘JJ’), (‘2’, ‘CD’), (‘months’, ‘NNS’)]
//where VBP is defined as Verb Present Tense, PRP as Pronoun,
DT //as Determiner, JJ as adjective, CD as numeral and NNS as
noun //( plural )

The named-entity recognition and extractor 550 comprises different extractors for extracting different types of phrases/Named-Entities against the tokenized texts/user actions. For example, the named-entity recognition and extractor 550 comprises an action extractor 551 configured to extract specific action in the user command/action. Terms such as “show”, “tell”, “graph”, “find” besides “who”, “what”, “how much” and “where” are commonly used terms indicating commands/actions in business intelligence. An action must be identified in order for the system 200 to determine the most optimal SQL generation and the correct visualization for rendering output data from the user data warehouse. An action may be extracted from a user question by scanning POS-tagged terms/phrases, and only pulling phrases that have been tagged either as Verb or WRB (i.e., Wh-adverb such as how, where, etc.). For example, in Table 3 above, the term “show” is the action/command to perform.

Action can be divided into multiple types in order to further fine-tune SQL and the appropriate visualization. For example, if the visualization specified is a singular data point, a singular data point is returned (i.e., a single result for satisfying the user question). Generally speaking, the identification of this type of action can be derived from phrases that have been POS-tagged as WRB. Examples of user questions invoking this type of action include “How much sales did we make in Oct 2015?”, “What department made most sales in Nov 2015?”, etc. As another example, if the visualization specified are multiple data points, multiple data points are returned (e.g., output/results may be returned in a graphical format). Examples of user questions invoking this type of action include “Show me all the sales in 2015”. The named-entity recognition and extractor 550 further comprises a visualization extractor 556 for determining a preferred visualization, if specified.

The named-entity recognition and extractor 550 further comprises a metric extractor 552 configured to extract one or more metric phrases from a user question and validate the extracted metric phrases against metadata information 520 for the user data warehouse.

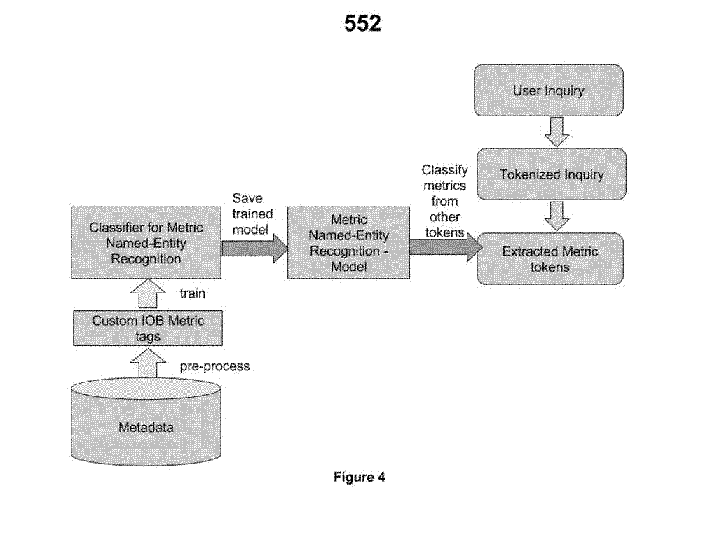

FIG. 4 illustrates an example of the process implemented by the metric extractor 552, in accordance with an embodiment of the invention. Prior to extracting metric phrase, system needs to pull all the metrics out of metadata and use these metrics as training sets for our named-entity metric extractor. And later, the training process of identifying metrics can be done using supervised learning model along with running a custom IOB tagging. IOB tags of mapped metrics provides another level of annotations that can be used as new training sets for the supervised learning model or known as classifier. When the model is trained, the system 200 simply runs the trained model against the tokenized user question. When there is a metric found within the user question, the model immediately tags the underlying tokens for this metric as a metric-entity. Once all these metric-entities have been identified, the system 200 simply extracts the corresponding tokens.

Returning to FIG. 2, the named-entity recognition and extractor 550 further comprises a dimension extractor 553 configured to extract one or more dimension phrases from a user question, and validate the extracted dimension phrases against the metadata information 520. Examples of user questions including dimensional information include “Show me sales for the last 6 months broken down by country and product”, “Display the chart of sales since January 2015 broken down by department”, etc. Similar to extracting metric phrases, system 200 needs to pull all the dimensions out of metadata and use these dimensions as training sets for our dimension extractor. And similar to the training phase of metric extractor above, the IOB tags of all the mapped dimensions provide new training sets and the system 200 simply feeds these IOB tags into a supervised learning model or known as a classifier. When the model is trained, the system 200 simply runs the trained model against the tokenized user question. When there is a dimension found within the user question, the model immediately tags the underlying token for this dimension as a dimension-entity. Once all these dimensions have been identified, the system 200 simply extracts the corresponding tokens associated to tag.

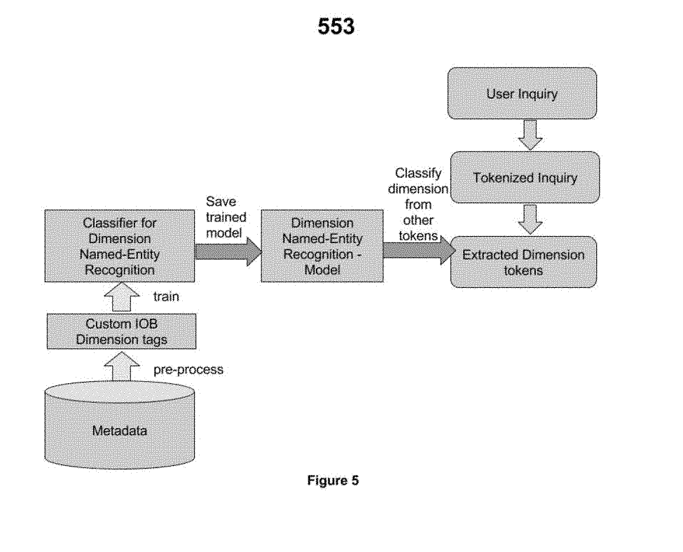

FIG. 5 illustrates an example process implemented by the dimension extractor 553, in accordance with an embodiment of the invention.

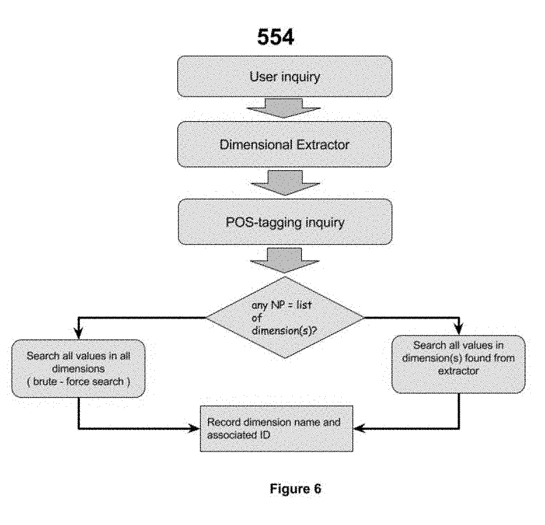

Returning to FIG. 2, the named-entity recognition and extractor 550 further comprises a dimensional value extractor 554 configured to extract one or more dimensional values from a user question. There are two ways a dimensional value are extracted. First, the system 200 runs dimensional extractor as exhibited in FIG. 6 and if a dimension name is found then does the lookup query to find and validate the values based on the extracted dimension against user data warehouse. Alternatively, the user 400 may inquire for a specific dimensional value without explicitly identifying a dimension name—this process requires two steps, wherein the first step comprises executing a query against all dimensions in the metadata information 520 to identify a correct dimension name, and the second step comprises brute-force queries against all dimensions in user data warehouse and look for specific dimensional value extracted from the user question. Examples of user questions comprising dimensional values include “How much sales did we have for East Coast Region?”, “How many new installs did we acquire for product ABC?”, etc.

FIG. 6 illustrates an example process implemented by the dimensional value extractor 554, in accordance with an embodiment of the invention.

Returning to FIG. 2, the named-entity recognition and extractor 550 further comprises a time extractor 555. The time extractor 555 is used to determine a timespan (i.e., time constraint) specified in a user question. If no timespan is specified, the system 200 assumes that ALLTIME is the default time constraint.

One or more time phrases extracted from the user question are translated into a Where clause in a SQL query generated later. The time extractor 555 is more complex than any of the other extractors mentioned above due to variations in natural language when referencing time. For example, a user question “Get me all the sales starting from December 2014” references the same timespan as a user question “Show all the monthly sales between since last 12/2014 until now.”

In a learning stage, the system 200 is trained to learn and understand different time constraint operators that may be used in conjunction with time phrases. For example, the system 200 is taught to interpret the phrase “since Dec 2014” as “>=‘12/01/2014’”, and the phrase “from Jan 2015 to Dec 2015” as “‘01/01/2015’<=(date dimension)<=‘12/31/2015’”. Examples of phrases within a user question that represent the “>=” time constraint operator include “since”, “from”, “between”, etc. Examples of phrases within a user question that represent the “<=” time constraint operator include “to”, “until”, etc. Examples of phrases within a user question that represent the “=” time constraint operator (or IN clause) is “in”, etc.

After one or more time constraint operators within a user question have been identified, the system 200 identifies time phrases by applying a chunking and Named Entity Recognition Process, and extracting time phrases that have been identified as <TIME>.

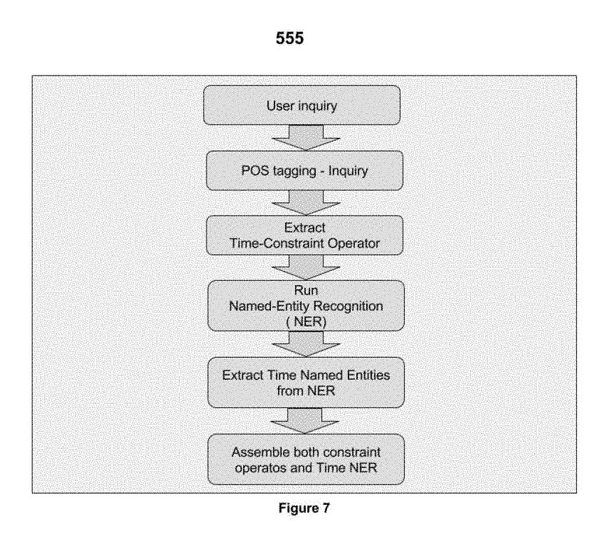

FIG. 7 illustrates an example process implemented by the time extractor 555, in accordance with an embodiment of the invention.

Returning to FIG. 2, the applications 215 further comprise a SQL generator 560 configured to collect all information/data points derived from one or more of the extractors described above, and compile the information/data points collected to generate a correct SQL statement to run against the user data warehouse.

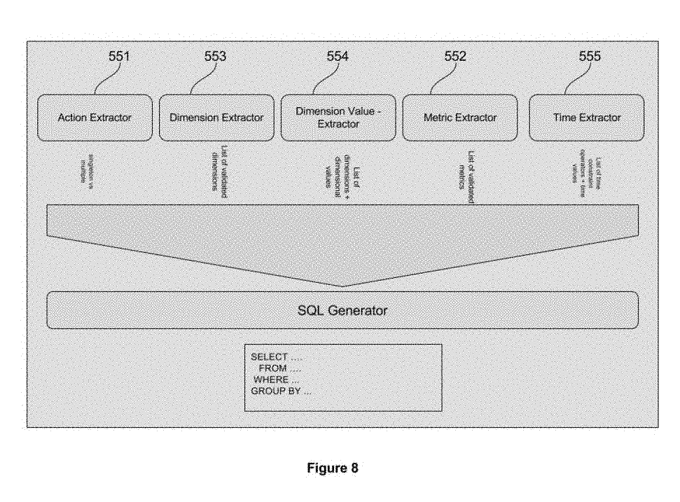

FIG. 8 illustrates different information or extracted named-entities from different extractors 550 and feed them into a SQL generator 560, in accordance with an embodiment of the invention.

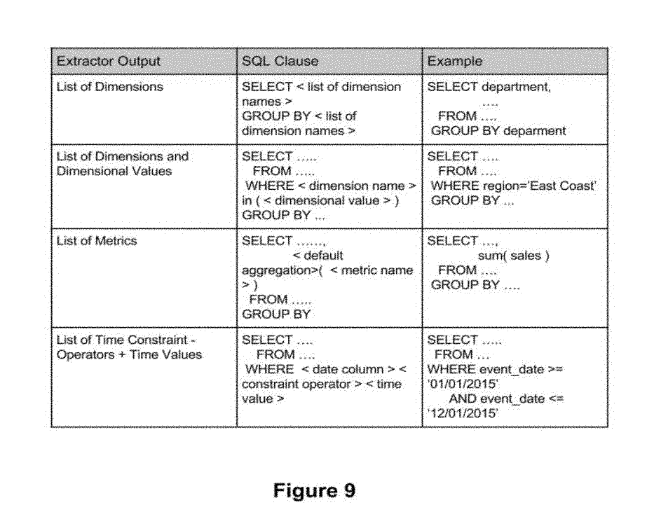

FIG. 9 illustrates an example rule-based SQL generation procedure implemented by the SQL generator 560 for generating queries in SQL syntax, in accordance with an embodiment of the invention. As shown in this figure, the SQL generation is simply constructed by checking the extracted entities. An example of this construction is when dimension is extracted from the user inquiry then the corresponding column of this dimension derived from the metadata mapping from FIG. 3 is used as GROUPING column in the GROUP-BY style of SQL. The same mechanism employed if metric is extracted where the system 200 will construct SQL by adding aggregation operation along with the corresponding metric column name derived from metadata mapping from FIG. 3 into column list of generated SQL. However, if there is a dimensional value found in the extraction step then this value along with the column name of the associated dimension is declared as a WHERE clause in the SQL construction.

Returning to FIG. 2, the applications 215 further comprise a visualization rendering engine 580 and a SQL converter 590. After a generated SQL query is run against the user data warehouse, and one or more results are retrieved from the user data warehouse, the SQL converter 590 and the visualization rendering engine 580 convert and render the results as one or more appropriate Visualization components (e.g., a type of graph best suited to represent the results, etc.). In one embodiment, the visualization rendering engine 580 utilizes a heuristic model to determine a type of visualization most suitable for the user question and the user. The visualization rendering engine 580 makes a determination based on two factors: type of data, and amount of data.

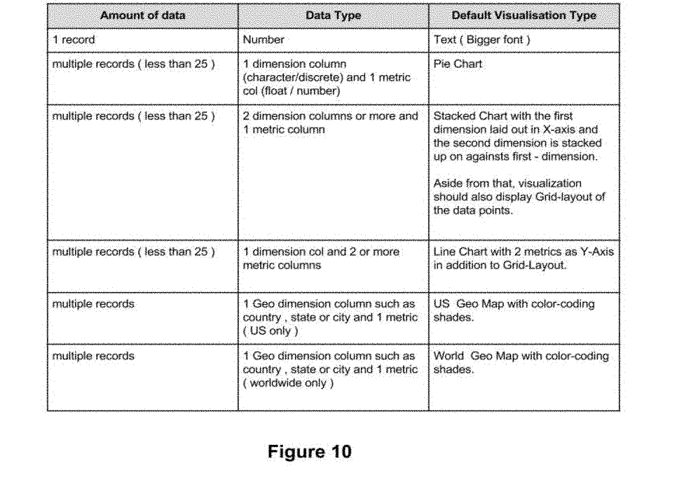

FIG. 10 illustrates an example heuristic model including heuristic rules utilized by the visualization rendering engine 580, in accordance with an embodiment of the invention.

While certain exemplary embodiments of a system for converting natural language questions into queries compatible with a data management platform (e.g., queries in SQL syntax) based on a dimensional model have been described and shown in the accompanying figures, it is to be understood that such embodiments are merely illustrative of and not restrictive on the broad invention, and that this invention not be limited to the specific constructions and arrangements shown and described, since various other modifications may occur to those ordinarily skilled in the art. The description and figures are provided solely as examples to aid the reader in understanding the invention. The description and figures are not intended, and are not to be construed, as limiting the scope of this invention in any manner. Although certain embodiments and examples have been provided, it will be apparent to those skilled in the art based on the disclosures herein that changes in the embodiments and examples shown may be made without departing from the scope of this invention.

1. A method of providing automatic business intelligence reports by converting an analytical question in natural language into a SQL-query and run this generated query against SQL-based data warehouse or SQL-based big data platform, said method comprising the steps of:
(a) storing a metadata of metrics including corresponding metric phrases and dimensions and corresponding dimension phrases based on a dimensional model of a data warehouse or big data;
(b) training named entity recognition process for recognizing metrics and dimensions based on said metadata by running machine learning classifier;
(c) breaking up said natural language question into a set of tokens;
(d) assigning part of the speech based on the said tokens;
(e) extracting dimensions and metrics out of said tokens by running said named entity recognition process;
(f) extracting dimension values out of said tokens by filtering noun phrase from said part of the speech;
(g) extracting timeframe out of said tokens by running a named entity recognition designed to extract time and date;
(h) forming said database query by running a rule-based SQL generation procedure based on said dimensions, said metrics, said dimension values and said timeframe;
(i) running said database query against said data warehouse and pull the result sets.
